(19) United States
(12) Patent Application Publication
(10) Pub. No.: US 2019/0289532 A1
(43) Pub. Date: Sep. 19, 2019

(54) METHOD AND USER EQUIPMENT FOR RECEIVING SYSTEM INFORMATION, AND METHOD AND BASE STATION FOR TRANSMITTING SYSTEM INFORMATION

(71) Applicant: LG ELECTRONICS INC., Seoul (KR)

(72) Inventors: Seungjune YI, Seoul (KR); Youngdae LEE, Seoul (KR); Sunyoung LEE, Seoul (KR)

(73) Assignee: LG ELECTRONICS INC., Seoul (KR)

(21) Appl. No.: 16/317,517

(22) PCT Filed: Jul. 13, 2017
(86) PCT No.: PCT/KR2017/007501

§ 371 Date: Jan. 11, 2019

Related U.S. Application Data
(60) Provisional application No. 62/361,520, filed on Jul. 13, 2016.

(51) Int. Cl. H04W 48/14; H04W 48/12; H04W 80/02; H04L 1/16; H04W 76/11; H04W 48/16

(52) U.S. Cl. CPC H04W 48/14; H04W 48/12; H04W 80/02; H04L 5/0053; H04W 76/11; H04W 48/16; H04L 1/1614

(57) ABSTRACT

In the present invention, a user equipment (UE) transmits a SI request (SIR) medium access control (MAC) control element (CE) for requesting one or more SIs. The UE receives the requested one or more SIs on a cell. The SIR MAC CE includes information indicating which SI among a plurality SIs used in the RAT system the UE requests.

### TECHNICAL FIELD

The present invention relates to a wireless communication system, and more particularly, to a method for receiving or transmitting system information and an apparatus therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC (mMCT), and ultra-reliable and low latency communication (URLLC), is being discussed.

### DISCLOSURE

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

Also, with development of smart devices, a new scheme for efficiently transmitting/receiving a small amount of data or efficiently transmitting/receiving data occurring at a low frequency is required.

Also, a method for transmitting/receiving signals effectively in a system supporting new radio access technology is required.

The technical objects that can be achieved through the present invention are not limited to what has been particularly described hereinabove and other technical objects not described herein will be more clearly understood by persons skilled in the art from the following detailed description.

### Technical Solution

In an aspect of the present invention, provided herein is a method of receiving, by a user equipment (UE), system information (SI) in a radio access technology (RAT) system. The method comprises: transmitting, by the UE, a SI request (SIR) medium access control (MAC) control element (CE) for requesting one or more SIs; and receiving, by the UE, the requested one or more SIs on a cell. The SIR MAC CE includes information indicating which SI among a plurality SIs used in the RAT system the UE requests.

In another aspect of the present invention, provided herein is a user equipment (UE) for receiving system information (SI) in a radio access technology (RAT) system. The UE comprises a radio frequency (RF) unit, and a processor configured to control the RF unit. The processor is configured to: control the RF unit to transmit a SI request (SIR) medium access control (MAC) control element (CE) for requesting one or more SIs; and control the RF unit to receive the requested one or more SIs on a cell. The SIR MAC CE includes information indicating which SI among a plurality SIs used in the RAT system the UE requests.

In further another aspect of the present invention, provided herein is a method of transmitting, by a base station (BS), system information (SI) in a radio access technology (RAT) system. The method comprises: receiving, by the BS, a SI request (SIR) medium access control (MAC) control element (CE) for requesting one or more SIs from a user equipment (UE); and transmitting, by the BS, the requested one or more SIs on a cell. The SIR MAC CE includes information indicating which SI among a plurality SIs used in the RAT system the UE requests.

In still further another aspect of the present invention, provided herein is a base station (BS) for transmitting system information (SI) in a radio access technology (RAT) system. The BS comprises: a radio frequency (RF) unit, and a processor configured to control the RF unit. The processor is configured to: control the RF unit to receive a SI request (SIR) medium access control (MAC) control element (CE) for requesting one or more SIs from a user equipment (UE); and control the RF unit to transmit the requested one or more SIs on a cell. The SIR MAC CE includes information indicating which SI among a plurality SIs used in the RAT system the UE requests.

In each aspect of the present invention, the SIR MAC CE may include a bitmap, where the bitmap includes a plurality of bits respectively corresponding to the plurality SIs.

In each aspect of the present invention, the bitmap may have a fixed size.

In each aspect of the present invention, the SIR MAC CE may include SI identity list, where the SI identity list includes a SI identity for each SI that the UE requests.

In each aspect of the present invention, the SIR MAC CE may include an extension field indicating whether another SI identity is included in a next byte.

In each aspect of the present invention, the UE may transmit length information of the SIR MAC CE. The BS may receive length information of the SIR MAC CE.

In each aspect of the present invention, the UE may transmit an identity of the UE along with the SIR MAC CE. The BS may receive an identity of the UE along with the SIR MAC CE.

In each aspect of the present invention, the SIR MAC CE is transmitted on a contention based channel.

In each aspect of the present invention, the BS may transmit essential SI on the cell. The essential SI may include configuration information for the contention based channel. the UE may acquire the essential SI on the cell.

The above technical solutions are merely some parts of the embodiments of the present invention and various embodiments into which the technical features of the present invention are incorporated can be derived and understood by persons skilled in the art from the following detailed description of the present invention.

### Advantageous Effects

According to the present invention, radio communication signals can be efficiently transmitted/received. Therefore, overall throughput of a radio communication system can be improved.

According to one embodiment of the present invention, a low cost/complexity UE can perform communication with a base station (BS) at low cost while maintaining compatibility with a legacy system.

According to one embodiment of the present invention, the UE can be implemented at low cost/complexity.

According to one embodiment of the present invention, the UE and the BS can perform communication with each other at a narrowband.

According to an embodiment of the present invention, delay/latency occurring during communication between a user equipment and a BS may be reduced.

Also, it is possible to efficiently transmit/receive a small amount of data for smart devices, or efficiently transmit/receive data occurring at a low frequency.

Also, signals in a new radio access technology system can be transmitted/received effectively.

According to an embodiment of the present invention, a small amount of data may be efficiently transmitted/received.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 is a view schematically illustrating a network structure of an E-UMTS as an exemplary radio communication system.

FIG. 2 is a block diagram illustrating network structure of an evolved universal mobile telecommunication system (E-UMTS).

FIG. 3 is a block diagram depicting architecture of a typical E-UTRAN and a typical EPC.

FIG. 4 is a diagram showing a control plane and a user plane of a radio interface protocol between a UE and an E-UTRAN based on a 3GPP radio access network standard.

FIG. 5 is a view showing an example of a physical channel structure used in an E-UMTS system.

FIG. 6 shows a system information delivery mechanism available in new radio access technology (New RAT) system.

FIG. 7 and FIG. 8 show examples of formats of system information request (SIR) medium access control (MAC) control element (CE) according to the present invention.

FIG. 9 is a block diagram illustrating elements of a transmitting device 100 and a receiving device 200 for implementing the present invention.

### MODE FOR INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-1-DMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption.” This may also mean that a subject to receive the channel receives or decodes the channel in a form conforming to the “assumption,” on the assumption that the channel has been transmitted according to the “assumption.”

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell.

Meanwhile, a 3GPP LTE/LTE-A system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the 3GPP LTE-A standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

In the present invention, “PDCCH” refers to a PDCCH, a EPDCCH (in subframes when configured), a MTC PDCCH (MPDCCH), for an RN with R-PDCCH configured and not suspended, to the R-PDCCH or, for NB-IoT to the narrowband PDCCH (NPDCCH).

In the present invention, for dual connectivity operation the term “special Cell” refers to the PCell of the master cell group (MCG) or the PSCell of the secondary cell group (SCG), otherwise the term Special Cell refers to the PCell. The MCG is a group of serving cells associated with a master eNB (MeNB) which terminates at least S1-MME, and the SCG is a group of serving cells associated with a secondary eNB (SeNB) that is providing additional radio resources for the UE but is not the MeNB. The SCG is comprised of a primary SCell (PSCell) and optionally one or more SCells. In dual connectivity, two MAC entities are configured in the UE: one for the MCG and one for the SCG. Each MAC entity is configured by RRC with a serving cell supporting PUCCH transmission and contention based Random Access. In this specification, the term SpCell refers to such cell, whereas the term SCell refers to other serving cells. The term SpCell either refers to the PCell of the MCG or the PSCell of the SCG depending on if the MAC entity is associated to the MCG or the SCG, respectively.

In the present invention, “C-RNTI” refers to a cell RNTI, “G-RNTI” refers to a group RNTI, “P-RNTI” refers to a paging RNTI, “RA-RNTI” refers to a random access RNTI, “SC-RNTI” refers to a single cell RNTI″, “SL-RNTI” refers to a sidelink RNTI, and “SPS C-RNTI” refers to a semi-persistent scheduling C-RNTI.

For terms and technologies which are not specifically described among the terms of and technologies employed in this specification, 3GPP LTE/LTE-A standard documents, for example, 3GPP TS 36.211, 3GPP TS 36.212, 3GPP TS 36.213, 3GPP TS 36.300, 3GPP TS 36.321, 3GPP TS 36.322, 3GPP TS 36.323 and 3GPP TS 36.331 may be referenced.

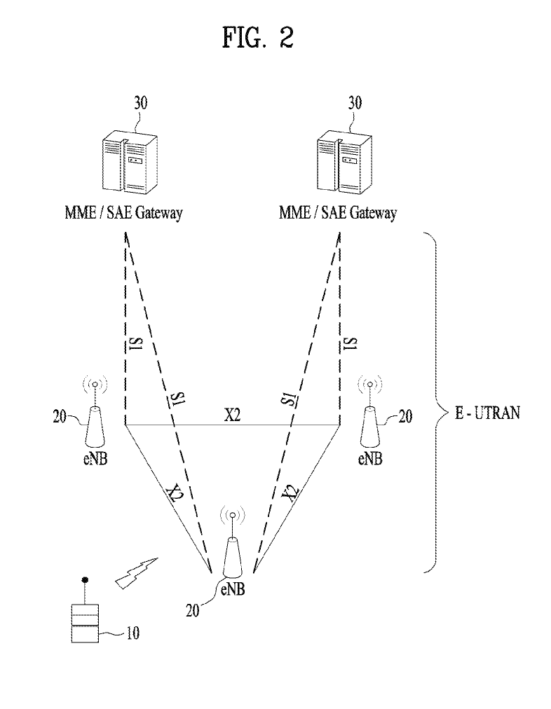

FIG. 2 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNB 20 to UE 10, and “uplink” refers to communication from the UE to an eNB.

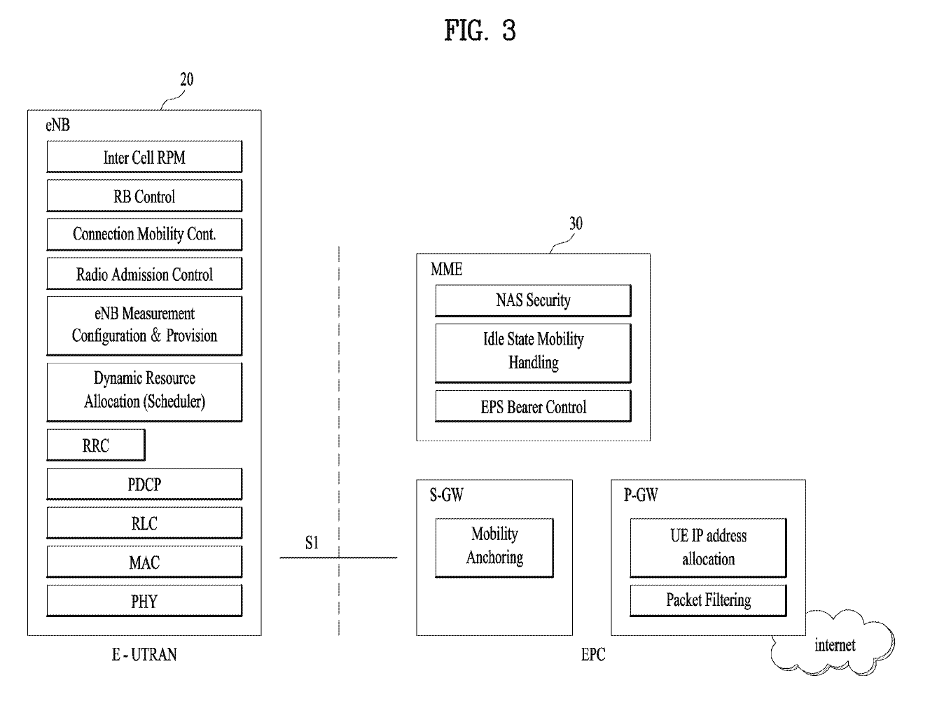

FIG. 3 is a block diagram depicting architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

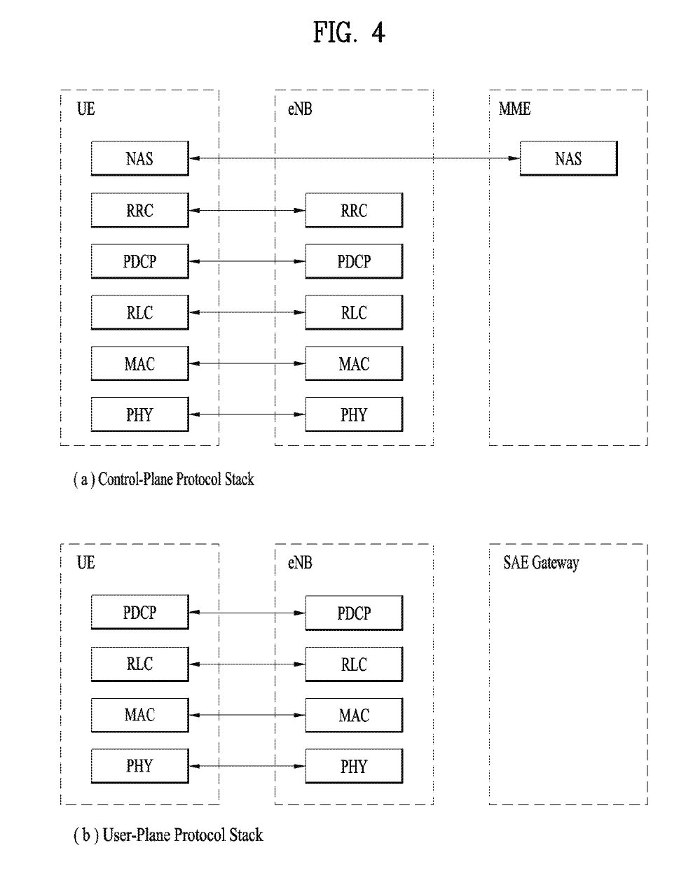

FIG. 4 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

Layer 1 (i.e. L1) of the LTE/LTE-A system is corresponding to a physical layer. A physical (PHY) layer of a first layer (Layer 1 or L1) provides an information transfer service to a higher layer using a physical channel. The PHY layer is connected to a medium access control (MAC) layer located on the higher layer via a transport channel Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

Layer 2 (i.e. L2) of the LTE/LTE-A system is split into the following sublayers: Medium Access Control (MAC), Radio Link Control (RLC) and Packet Data Convergence Protocol (PDCP). The MAC layer of a second layer (Layer 2 or L2) provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

Layer 3 (i.e. L3) of the LTE/LTE-A system includes the following sublayers: Radio Resource Control (RRC) and Non Access Stratum (NAS). A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

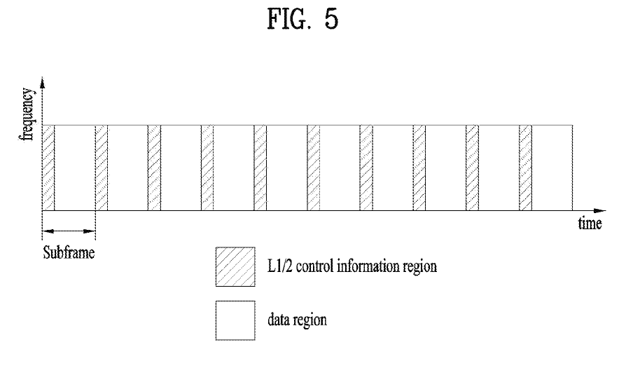

FIG. 5 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. In FIG. 5, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

A time interval in which one subframe is transmitted is defined as a transmission time interval (TTI). Time resources may be distinguished by a radio frame number (or radio frame index), a subframe number (or subframe index), a slot number (or slot index), and the like. TTI refers to an interval during which data may be scheduled. For example, in the current LTE/LTE-A system, a opportunity of transmission of an UL grant or a DL grant is present every 1 ms, and the UL/DL grant opportunity does not exists several times in less than 1 ms. Therefore, the TTI in the current LTE/LTE-A system is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

A fully mobile and connected society is expected in the near future, which will be characterized by a tremendous amount of growth in connectivity, traffic volume and a much broader range of usage scenarios. Some typical trends include explosive growth of data traffic, great increase of connected devices and continuous emergence of new services. Besides the market requirements, the mobile communication society itself also requires a sustainable development of the eco-system, which produces the needs to further improve system efficiencies, such as spectrum efficiency, energy efficiency, operational efficiency and cost efficiency. To meet the above ever-increasing requirements from market and mobile communication society, next generation access technologies are expected to emerge in the near future.

Work has started in ITU and 3GPP to develop requirements and specifications for new radio systems, as in the Recommendation ITU-R M.2083 “Framework and overall objectives of the future development of IMT for 2020 and beyond”, as well as 3GPP SA1 study item New Services and Markets Technology Enablers (SMARTER) and SA2 study item Architecture for NR System. It is required to identify and develop the technology components needed for successfully standardizing the NR system timely satisfying both the urgent market needs, and the more long-term requirements set forth by the ITU-R IMT-2020 process. In order to achieve this, evolutions of the radio interface as well as radio network architecture have to be considered in the “New Radio Access Technology.”

In the legacy LTE/LTE-A system, the system information is divided into master information block (MIB) and a number of system information blocks (SIB s). The following table provides the details about their functions.

TABLE 1

| | | Transmission |
|---|---|---|
| | | type and |
| SIB | | physical |
| name | Function description | channel |
| MIB | Limited number of most essential and most frequently | Broadcast on |
| | transmitted parameters that are needed to acquire other | PBCH |
| | information from the cell | |
| SIB1 | Cell access and cell reselection related info, scheduling info list | Broadcast on |
| SIB2 | Radio resource configuration that is common for all U Es | PDSCH |
| SIB3 | Cell reselection configuration | |
| SIB4 | Intra-frequency neighboring cell list, black list | |
| SIB5 | Inter-frequency neighboring cell list | |
| SIB6 | Neighboring cell list for UTRAN | |
| SIB7 | Neighboring cell list for GSM | |
| SIB8 | Neighboring cell list for CDMA2000 | |
| SIB9 | HeNB indicator | |
| SIB10 | EWTS primary notification information | |
| SIB11 | EWTS secondary notification information | |
| SIB12 | CMAS notification | |
| SIB13 | Control info for MBMS | |
| SIB14 | EAB parameters | |
| SIB15 | MBMS Service Area Identities | |
| SIB16 | Information related to GPS time and Coordinated Universal | |
| | Time | |
| SIB17 | Information relevant for traffic steering between E-UTRAN | |
| | and WLAN | |
| SIB18 | Information and resource configuration for sidelink | |
| | communication | |
| SIB19 | Information and resource configuration for sidelink discovery | |
| SIB20 | Control information associated transmission of MBMS using | |
| | SC-PTM | |

In LTE, all applicable system information is broadcasted periodically using the physical resources of the corresponding cell. The information is broadcasted using different mechanisms: MIB is transmitted using the broadcast channel (BCH) with a periodicity of 40 ms, SIB1 is transmitted using downlink shared channel (DL-SCH) with a periodicity of 80 ms, and other applicable SIBs are transmitted using DL-SCH with time-frequency domain scheduling by SI-RNTI on the PDCCH each with a configurable periodicity and each within a time window. System information is provided using dedicated signaling as part of the RRC reconfiguration procedure for (P)SCells for a UE configured with carrier aggregation and/or dual connectivity.

The above broadcasting approach is well-suited mainly for macro cell deployments. However, it may not be optimal in other scenarios. A first possible shortcoming of the broadcasting approach is that resources may be wasted when only few UEs (or none) are camping on the cell, are accessing the system and/or are interested in certain types of SIBs. A second possible shortcoming of the broadcasting approach is the latency induced by the nature of the periodic broadcasting when initially acquiring system information. For some SIBs, a UE has to wait for the next period until the relevant SIB(s) is transmitted; an average latency corresponding to half of the configured period is typically necessary before a UE can determine whether or not a feature of the system is accessible. A third shortcoming of the broadcasting approach is the impact of the extensibility of the broadcasting approach as the system evolves and as new features are being added. As the amount of system information increases, more resources are required for the broadcasting approach. As new information messages are added, each may need to be broadcasted in a new time window which may further impact a UE's power consumption as it may have to wake up more often. Especially, the system information of THE LTE system became bigger and bigger gradually from 3GPP LTE Release 8 to support new features, and this tendency continues according to current LTE mechanism. However, the newly introduced SIBs are only needed by the UEs supporting those specific features. Note that these SIBs are continuously broadcasting periodically even though only a few or none UEs are requiring them. That is to say, the efficiency of the broadcasting of these specific SIBs is very low.

In addition to the above possible shortcomings of the broadcasting approach, there are a number of other aspects to consider that may be specific to the NR access. Firstly, it can be expected that NR will be deployed in high frequency bands and multiple beams may be needed to provide adequate coverage. In these conditions, using broadcasting methods similar to LTE (i.e. broadcasting on each beam) may not be suitable or efficient. Secondly, such NR deployments are expected to include macro deployments as well as a high density of cells with small coverage: for cells with large coverage, the broadcasting approach for all applicable system information is well suited to provide functions such as system access, camping, mobility, etc. as the population of IDLE UEs is larger and the rate of system access is higher; for cells with smaller coverage, only few UEs may be in the area of a cell at any given time and those cell are better suited for dedicated transmissions while it would however remain desirable to efficiently support similar features and functions as a macro cell. Thirdly, with shorter TTIs being supported, it may become faster to acquire system information using dedicated signaling rather than waiting for periodically broadcasted system information. This may also be necessary to properly support URLLC services.

Therefore, in NR, some new mechanisms of delivering the system information to UE are being discussed.

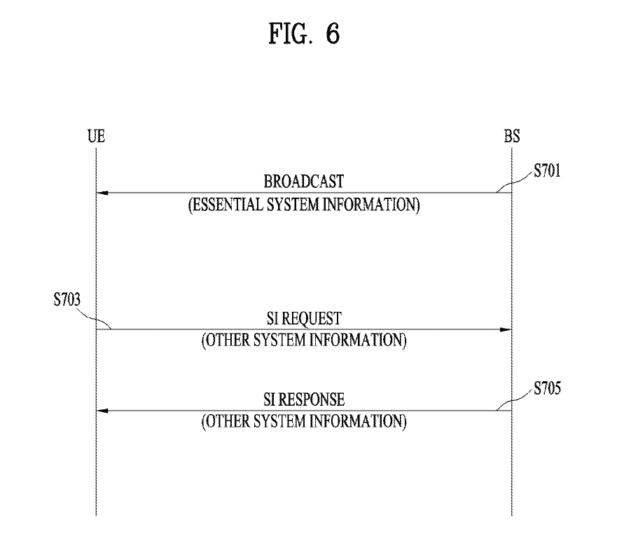

FIG. 6 shows a system information delivery mechanism available in new radio access technology (New RAT) system.

The common ground for the system information delivery scheme being studied in 5G New RAT (NR) is to introduce an on-demand system information delivery scheme. That is, (most) essential system information (e.g. MIB) is broadcast as prior art, but the other system information provided via dedicated signaling when the UE requests to provide. The most essential system information may minimally contain system information necessary for the UE to access uplink resources and to obtain further system information. For example, in LTE, the following could correspond to the minimal amount of information blocks for this group: MIB, SIB1 (access-related information e.g. PLMN, TAC, CellID, p-Max, frequency band indicator), and/or SIB2 (access barring information, RACH parameters, UL power control).

Referring to FIG. 6, most essential system information required by the UE for camping on detected cell and subsequently accessing the camped cell is broadcasted while the rest of the system information can be provided to the UE on demand.

New mechanisms are under discussion for a UE to request system information. One of the new mechanisms under discussion is that a UE transmits a random access preamble specific to a SI or a set of SIs which the UE wants to obtain, where respective random access preambles specific to SIs or sets of SIs are reserved and indicated in broadcasted essential SI. This mechanism is disadvantageous in that random access preambles should be reserved and in that contention would get worse in the cell as the number of UEs trying to obtain SIs increases.

The present invention proposes a robust mechanism which allows a UE to request specific system information and has low signaling overhead. Especially, the present invention proposes that a system information (SI) request MAC CE (SIR MAC CE) be used for a UE to request interested SIs. The SIR MAC CE includes indication(s) of SI(s) that the UE is interested in. The present invention is advantageous in that a UE can request a large number of SIs at once while keeping contention among UEs low.

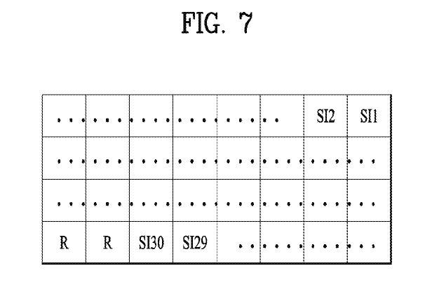

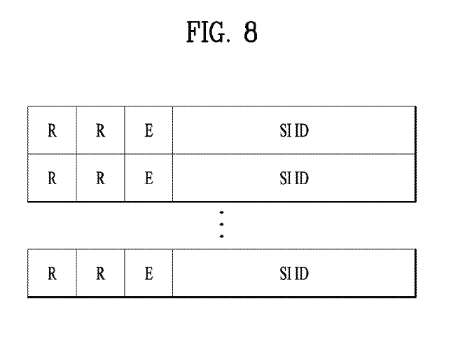

FIG. 7 and FIG. 8 show examples of formats of system information request (SIR) medium access control (MAC) control element (CE) according to the present invention. Especially, FIG. 7 shows an example of BITMAP SIR MAC CE according to the present invention, and FIG. 8 shows an example of LIST SIR MAC CE according to the present invention.

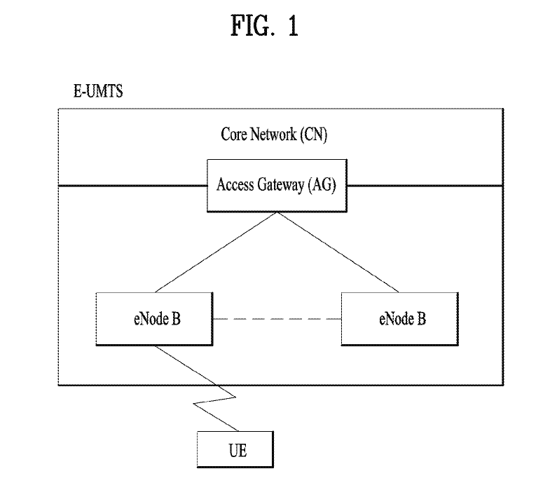

Referring to FIG. 7, a BITMAP SIR MAC CE is used as a format of the SIR MAC CE. The BITMAP SIR MAC CE has a fixed size of a bitmap, where each field of the bitmap corresponds to each SI. If a UE wants to request, e.g., SI2, then the UE sets the field of SI2 to 1 and the fields of other SIs to 0. The UE can request multiple SIs by setting corresponding bit fields to 1. The size of the bitmap may depend on how many SIs are introduced in the NR system. For example, if the number of SIs is 17-24, then 3 bytes bitmap is used, and if the number of SIs is 25-32, then 4 bytes bitmap is used. For the byte-alignment of the BITMAP SIR MAC CE, the remaining fields of the bitmap are filled with reserved bits or padding bits. The number of SI fields in the bitmap is the same as the number of SI defined in the corresponding system. The FIG. 1 shows an example of BITMAP SIR MAC CE when there are total 30 SIs defined in the corresponding system. To identify the BITMAP SIR MAC CE, an identifier may be included in the PDU header. For example, the UE identity (ID) may be included in the BITMAP SIR MAC CE or in the PDU containing the BITMAP SIR MAC CE.

Referring to FIG. 8, a LIST SIR MAC CE is used as a format of the SIR MAC CE. The LIST SIR MAC CE has a SI ID list with a variable size, where the UE includes the ID of the SI, that the UE requests, in the SI ID list. If the UE wants to request, e.g., SI2 and SI4, then the UE includes SI ID=2 and SI ID=4 in the LIST SIR MAC CE. The UE can request multiple SIs by including corresponding SI IDs. The size of the SI ID field may depend on how many SIs are introduced in the NR system. For example, if the number of SIs is 17-32, then 5 bytes SI ID field is used, and if the number of SIs is 33-64, then 6 bytes SI ID field is used. For the byte-alignment of LIST SIR MAC CE, the remaining fields of the LIST SIR MAC CE are filled with reserved bits or padding bits. As the UE can include as many SI IDs as it requests, there should be an indicator to indicate whether another SI ID is included in the next byte or not. For this purpose, an extension (E) field may be also included in the LIST SIR MAC CE, where E=1 means that another SI ID is included in the next byte, and the E=0 means that this is the last SI ID and there is no other SI ID included in the next byte. To identify LIST SIR MAC CE, an identifier may be included in the PDU header. To indicate the variable size of the LIST SIR MAC CE, a length (L) field may be included in the PDU header. The UE ID may be included in the LIST SIR MAC CE or in the PDU containing the LIST SIR MAC CE.

The UE can transmit the SIR MAC CE in both RRC IDLE mode and RRC CONNECTED mode. For the transmission of the SIR MAC CE in RRC IDLE, a new channel called SI request channel (SIRCH) may be used. The characteristics of the SIRCH may be as follows.
SIRCH is used for transmission of SIR MAC CE.
SIRCH can be used by both RRC IDLE and RRC CONNECTED UEs.
SIRCH is a contention based UL channel Multiple UEs can transmit its own SIR MAC CE on the same SIRCH, in which case collision occurs.
The configuration information (e.g. UL timing, Tx power, frequency info, bandwidth info, etc.) of the SIRCH is provided by essential system information (e.g. MIB) which is broadcasted by the network.

The RRC CONNECTED UE can transmit the SIR MAC CE either on SIRCH or PUSCH.

A UE can obtain SI(s) using a SIR MAC CE according to the present invention as described above. For example, SI(s) can be provided to a UE by a BS according to the following procedure.
When the UE camps on a cell, the UE reads essential system information, e.g. MIB, broadcasted by the cell. The UE also acquires the configuration information of PUSCH used for transmission of SIR MAC CE from the essential system information.
The UE checks whether the SI that the UE wants is broadcasted or not. If the SI that the UE wants is not broadcasted, the UE transmits a SIR MAC CE to the network.

If the SI that the UE wants is required for RRC IDLE, i.e., if the SI that the UE wants is SI used when the UE is in RRC IDLE, the UE may transmit the SIR MAC CE via a SIRCH. Referring to Table 1, for example, SIB3 to SIB8 may be the SI used when the UE is in RRC IDLE. If the SI that the UE wants is required for RRC CONNECTED, i.e., if the SI that the UE wants is SI used when the UE is in RRC CONNECTED, the UE may first make the RRC connection and then transmit the SIR MAC CE via a PUSCH. Referring to Table 1, for example, SIB9 and SIB20 may be the SI used when the UE is in RRC CONNECTED. SIB1 and SIB2 are used during RRC IDLE and during RRC CONNECTED.
When the network receives SIR MAC CE, it broadcasts or unicasts the requested SI. Broadcast may be done via a BCH, and unicast may be done via a PDSCH dedicated to the UE.

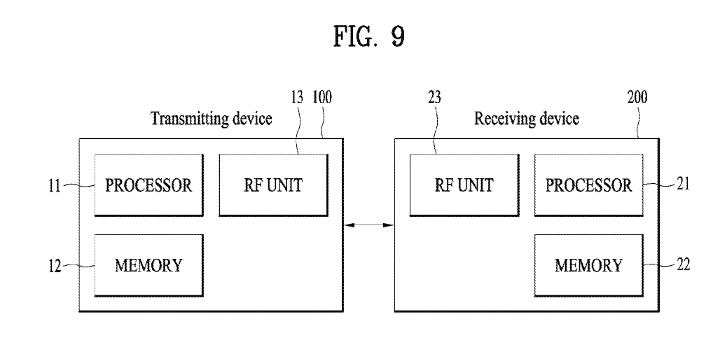

FIG. 9 is a block diagram illustrating elements of a transmitting device 100 and a receiving device 200 for implementing the present invention.

The transmitting device 100 and the receiving device 200 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 200 is the reverse of the signal processing process of the transmitting device 100. Under control of the processor 21, the RF unit 23 of the receiving device 200 receives radio signals transmitted by the transmitting device 100. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 100 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 200. An RS transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 100 in UL and as the receiving device 200 in DL. In the embodiments of the present invention, an eNB operates as the receiving device 200 in UL and as the transmitting device 100 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

A UE processor may control the UE RF unit to transmit a SI request (SIR) medium access control (MAC) control element (CE) for requesting SI(s), and control the UE RF unit to receive the requested SI(s) on a cell. The UE processor may generate the SIR MAC CE to include information indicating which SI among a plurality of SIs used in a RAT system the UE requests. The UE processor may generate the SIR MAC CE including a bitmap, where a plurality of bits in the bitmap are respectively corresponding to the plurality of SIs used in the RAT system, as illustrated in FIG. 7. The UE processor may generate the SIR MAC CE including a SI identity (ID) list, where the SI ID list includes respective SI ID(s) for SI(s) that the UE requests, as illustrated in FIG. 8. The UE processor may control the UE RF unit to transmit an identity of the UE along with the SIR MAC CE. The UE processor may control the UE RF unit to transmit the SIR MAC CE on a contention based channel. The UE processor may control the UE RF unit to transmit the SIR MAC CE on the contention based channel according to configuration information for the contention based channel. The UE processor may control the UE RF unit to receive essential SI on the cell and acquire the configuration information from the essential SI.

An eNB processor may control the eNB RF unit to receive a SI request (SIR) medium access control (MAC) control element (CE) for requesting SI(s) from a UE, and control the eNB RF unit to transmit the requested SI(s) on a cell to the UE. The SIR MAC CE may include a bitmap, where a plurality of bits in the bitmap are respectively corresponding to the plurality of SIs used in the RAT system, as illustrated in FIG. 7. The SIR MAC CE may include a SI identity (ID) list, where the SI ID list includes respective SI ID(s) for SI(s) that the UE requests, as illustrated in FIG. 8. The eNB processor may control the eNB RF unit to receive an identity of the UE along with the SIR MAC CE. The eNB processor may control the eNB RF unit to receive the SIR MAC CE on a contention based channel. The eNB processor may control the eNB RF unit to broadcast essential SI on the cell. The eNB processor may generate the essential SI including the configuration information on the contention based channel. The eNB processor may control the eNB RF unit to receive the SIR MAC CE on the contention based channel according to the configuration information on the contention based channel.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a network node (e.g., BS), a UE, or other devices in a wireless communication system.

1. A method for receiving, by a user equipment (UE), system information (SI) in a radio access technology (RAT) system, the method comprising:
transmitting, by the UE, a SI request (SIR) medium access control (MAC) control element (CE) for requesting one or more SIs; and
receiving, by the UE, the requested one or more SIs on a cell,
wherein the SIR MAC CE includes information indicating which SI among a plurality SIs used in the RAT system the UE requests.

2. The method according to claim 1,
wherein the SIR MAC CE includes a bitmap, and
wherein the bitmap includes a plurality of bits respectively corresponding to the plurality SIs.

3. The method according to claim 1,
wherein the bitmap has a fixed size.

4. The method according to claim 1,
wherein the SIR MAC CE includes SI identity list, and
wherein the SI identity list includes a SI identity for each SI that the UE requests.

5. The method according to claim 4,
wherein the SIR MAC CE includes an extension field indicating whether another SI identity is included in a next byte.

6. The method according to claim 4, further comprising:
transmitting, by the UE, length information of the SIR MAC CE.

7. The method according to claim 1, further comprising:
transmitting, by the UE, an identity of the UE along with the SIR MAC CE.

8. The method according to claim 1,
wherein the SIR MAC CE is transmitted on a contention based channel.

9. The method according to claim 8,
acquiring, by the UE, essential SI on the cell,
wherein the essential SI includes configuration information for the contention based channel.

10. A user equipment (UE) for receiving system information (SI) in a radio access technology (RAT) system, the UE comprising:
a radio frequency (RF) unit, and
a processor configured to control the RF unit, the processor configured to:
control the RF unit to transmit a SI request (SIR) medium access control (MAC) control element (CE) for requesting one or more SIs; and
control the RF unit to receive the requested one or more SIs on a cell,
wherein the SIR MAC CE includes information indicating which SI among a plurality SIs used in the RAT system the UE requests.

11. The UE according to claim 10,
wherein the SIR MAC CE includes a bitmap, and
wherein the bitmap includes a plurality of bits respectively corresponding to the plurality SIs.

12. The UE according to claim 10,
wherein the bitmap has a fixed size.

13. The UE according to claim 10,
wherein the SIR MAC CE includes SI identity list, and
wherein the SI identity list includes a SI identity for each SI that the UE requests.

14. The UE according to claim 13,
wherein the SIR MAC CE includes an extension field indicating whether another SI identity is included in a next byte.

15. The UE according to claim 13,
wherein the processor is configured to control the RF unit to transmit length information of the SIR MAC CE.

16. The UE according to claim 10,
wherein the processor is configured to control the RF unit to transmit an identity of the UE along with the SIR MAC CE.

17. The UE according to claim 10,
wherein the SIR MAC CE is transmitted on a contention based channel.

18. The UE according to claim 17,
wherein the processor is configured to acquire essential SI on the cell, and
wherein the essential SI includes configuration information for the contention based channel.

19. A method for transmitting, by a base station (BS), system information (SI) in a radio access technology (RAT) system, the method comprising:
receiving, by the BS, a SI request (SIR) medium access control (MAC) control element (CE) for requesting one or more SIs from a user equipment (UE); and
transmitting, by the BS, the requested one or more SIs on a cell,
wherein the SIR MAC CE includes information indicating which SI among a plurality SIs used in the RAT system the UE requests.

20. A base station (BS) for transmitting system information (SI) in a radio access technology (RAT) system, the BS comprising:
a radio frequency (RF) unit, and
a processor configured to control the RF unit, the processor configured to:
control the RF unit to receive a SI request (SIR) medium access control (MAC) control element (CE) for requesting one or more SIs from a user equipment (UE); and
control the RF unit to transmit the requested one or more SIs on a cell,
wherein the SIR MAC CE includes information indicating which SI among a plurality SIs used in the RAT system the UE requests.
